(19) United States
(12) Patent Application Publication
(10) Pub. No.: US 2014/0122113 A1
(43) Pub. Date: May 1, 2014

(54) PROVIDING INDICATIONS OF CLINICAL-TRIAL CRITERIA MODIFICATIONS

(71) Applicant: CERNER INNOVATION, INC., KANSAS CITY, KS (US)

(72) Inventors: MARK A. HOFFMAN, JR., LEE'S SUMMIT, MO (US); KEVIN MATTHEW POWER, KANSAS CITY, MO (US); ANDREW MECKLER, STILWELL, KS (US); MAHCAMEH MOUSSAVI, LENEXA, KS (US); BONNIE LINN BATES, KANSAS CITY, MO (US)

(73) Assignee: CERNER INNOVATION, INC., KANSAS CITY, KS (US)

(21) Appl. No.: 14/139,593

(22) Filed: Dec. 23, 2013

Related U.S. Application Data
(62) Division of application No. 13/490,012, filed on Jun. 6, 2012.

(51) Int. Cl. G06F 19/00

(52) U.S. Cl. CPC G06F 19/363
USPC 705/2

(57) ABSTRACT

Systems and method for providing indications of trial-related attributes are provided. In embodiments, the method includes providing an indication to view a suggested clinical-trial criteria modification(s) that, if implemented, is expected to increase a number of patients eligible for a clinical trial. Thereafter, a suggested criterion modification for a clinical-trial criterion is received. The suggested criterion modification is based on a comparison of aggregated patient data associated with the clinical-trial criterion to the clinical-trial criterion. The indication of the suggested criterion modification for the clinical-trial criterion can be displayed.

### CROSS-REFERENCE TO RELATED APPLICATIONS

This application is a divisional of, and claims priority from, U.S. patent application Ser. No. 13/490,012, entitled “PROVIDING INDICATIONS OF CLINICAL-TRIAL CRITERIA MODIFICATIONS,” filed Jun. 6, 2012, which is related by subject matter to the invention disclosed in the commonly assigned U.S. patent application Ser. No. 13/490,023, filed Jun. 6, 2012, entitled “IDENTIFYING PATIENT ELIGIBILITY FOR CLINICAL TRIALS,” both of which are incorporated by reference herein in their entirety.

### BACKGROUND

Clinical trials are valuable to advancing patient healthcare. To run effective clinical trials, participants meeting specific criteria are needed. Recruiting participants to partake in clinical trials, however, can be costly and time consuming. Some estimates indicate that recruitment delays can cost a clinical-trial sponsor (e.g., a pharmaceutical company) up to one million dollars per day. Further, the lengthy process to recruit participants can delay completion of clinical trials. Nearly half of clinical trial delays result from participant enrollment problems. Such delays in performing clinical trials can result in slowing drug development, impeding healthcare research, and/or prolonging release of a new healthcare product into the market for use by patients that might benefit.

Recruitment delays oftentimes result from an inability to find potential participants that meet the criteria established for a clinical trial. In this regard, it is oftentimes difficult to find patients that meet the required criteria for a particular clinical trial. In the same manner, a patient may have difficulty finding a clinical trial, in which the patient is eligible or qualified to participate, that might facilitate successful treatment of a health condition.

Further, the number of potential participants for a clinical trial may be limited due to stringent eligibility criteria used to identify participants for the clinical trial. In such cases, inclusion criteria can be too difficult to meet or exclusion criteria may eliminate a large number of potential candidates resulting in lower than anticipated patient recruitment rates. Clinical-trial providers, however, often lack visibility to the impact of specific eligibility criteria on recruitment rates. Accordingly, it is difficult for clinical-trial providers to identify eligibility criteria to adjust to result in a greater number of potential candidates.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing indications of clinical-trial criteria modifications. In this regard, a clinical-trial provider can be provided with suggestions or recommendations for adjusting criteria associated with a clinical trial. To identify suggested criteria adjustments, clinical-trial criteria associated with a clinical trial can be compared to patient data for a plurality of patients that corresponds with the criteria. The suggested criteria adjustments can be identified using various data, such as, for example, an indication of success or failure of criteria in relation to the patients, a distribution of the patient data corresponding to criteria, an indication of an extent of absent data, etc. In addition to providing an indication of suggested criteria adjustments, in embodiments, an expected result for implementation of the suggested criteria adjustment can also be provided so that the clinical-trial provider can better evaluate whether the clinical trial would benefit from modifying the criteria.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram illustrating an exemplary system suitable for use in implementing embodiments of the present invention;

FIG. 3 is a flow diagram showing an exemplary method for providing clinical-trial data, in accordance with an embodiment of the present invention;

FIG. 4 is a flow diagram showing an exemplary method for providing patient data, in accordance with an embodiment of the present invention;

FIG. 5 is a flow diagram showing an exemplary method for performing clinical-trial analysis, in accordance with an embodiment of the present invention;

FIG. 6 is a flow diagram showing an exemplary method for performing clinical-trial analysis to obtain a patient report including one or more patient-related attributes, in accordance with an embodiment of the present invention;

FIG. 7 is a flow diagram showing another exemplary method for performing clinical-trial analysis to obtain a patient report including one or more patient-related attributes, in accordance with an embodiment of the present invention;

FIG. 8 is a flow diagram showing an exemplary method for performing clinical-trial analysis to obtain a clinical-trial report including one or more trial-related attributes, in accordance with an embodiment of the present invention;

FIG. 9 is a flow diagram showing another exemplary method for performing clinical-trial analysis to obtain a clinical-trial report including one or more trial-related attributes, in accordance with an embodiment of the present invention;

FIG. 10 is an illustrative screen display showing an exemplary view of a chart for a patient in which a clinician can view problems and diagnosis, in accordance with an embodiment of the present invention;

FIG. 11 is an illustrative screen display showing an exemplary view of a chart for a patient in which a clinician can view clinician notes, in accordance with an embodiment of the present invention;

FIG. 12 is an illustrative screen display showing an exemplary view of a chart for a patient in which a clinician can view one or more clinical trials for which the patient may be eligible, in accordance with an embodiment of the present invention; and

FIG. 13 provides an example of various trial-related attributes, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems for providing trial-related attributes. Utilizing the methods and systems described herein, clinical-trial criteria associated with a particular clinical trial can be compared to corresponding patient data associated with a plurality of patients, such as patients previously screened for the clinical trial. Upon analyzing, for example, a distribution of the patient data relative to the criteria and/or success or failure of patient data relative to the criteria, a suggested criteria modification can be determined or identified. Such a suggested criteria modification can be provided to the clinical-trial provider to assist in assessing the success of the clinical trial. The suggested criteria modification can facilitate increasing the potential number of patients eligible for the clinical trial. In addition to providing one or more suggested criteria modifications, other data can be provided, such as, for example, an indication of the success or failure of patient data relative to the criteria, an expected outcome for implementation of the suggested criteria modification, an indication of a criteria with near misses (i.e., patient nearly or almost satisfies the criteria), etc.

Accordingly, in one aspect, an embodiment of the present invention is directed to one or more computer-storage media having computer-executable instructions embodied thereon for performing a method for providing indications of trial-related attributes. The method includes aggregating data associated with a plurality of patients that corresponds with a criterion associated with a clinical trial. The criterion provides a qualification used to determine whether a patient is eligible for the clinical trial. Based on the aggregated data corresponding with the criterion for the clinical trial, clinical-trial attributes that indicate satisfaction of the criterion associated with the clinical trial are identified. The clinical-trial attributes indicating satisfaction of the criterion associated with the clinical trial are provided, for example, to a computing device.

In another aspect of the invention, an embodiment is directed to a computerized method for providing indications of clinical-trial criteria modifications. The method includes providing an indication to view one or more suggested clinical-trial criteria modifications that, if implemented, are expected to increase a number of patients eligible for a clinical trial. A suggested criterion modification for a clinical-trial criterion is determined based on a comparison of aggregated patient data associated with the clinical-trial criterion to the clinical-trial criterion. The indication of the suggested criterion modification for the clinical-trial criterion is displayed.

In a further aspect, an embodiment is directed to one or more computer-storage media having computer-executable instructions embodied thereon for performing a method for a method for providing indications of clinical-trial criteria modifications. The method includes receiving an indication to provide recommendations for adjusting clinical-trial criteria associated with a clinical trial to result in an increased number of eligible patients for the clinical trial. Data associated with a plurality of patients is analyzed. Such data corresponds with a first criterion associated with the clinical trial. An adjusted criterion value for the first criterion that, if implemented in association with the first criterion, is expected to increase a number of patients eligible for the clinical trial is recognized. The adjusted criterion value for the first criterion is provided to the computing device.

Having briefly described embodiments of the present invention, an exemplary operating environment suitable for use in implementing embodiments of the present invention is described below.

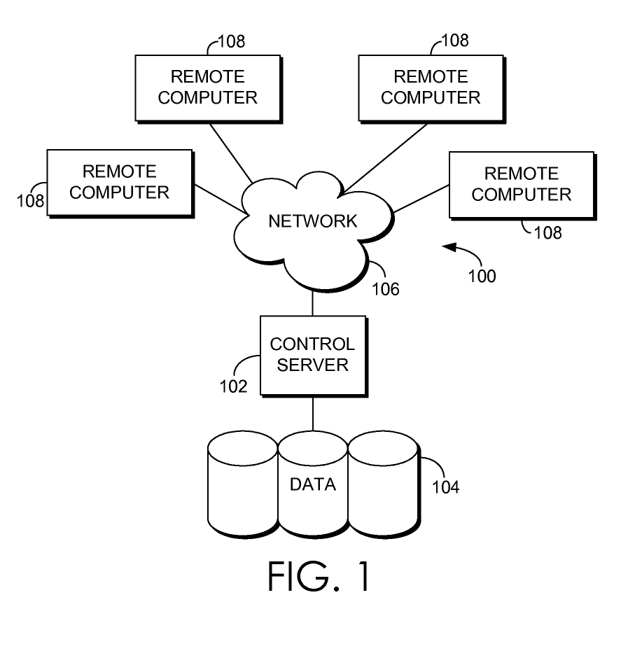

Referring to the drawings in general, and initially to FIG. 1 in particular, an exemplary computing system environment, for instance, a healthcare information computing system, on which embodiments of the present invention may be implemented is illustrated and designated generally as reference numeral 100. It will be understood and appreciated by those of ordinary skill in the art that the illustrated healthcare information computing system environment 100 is merely an example of one suitable computing environment and is not intended to suggest any limitation as to the scope of use or functionality of the invention. Neither should the healthcare information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including memory storage devices.

With continued reference to FIG. 1, the exemplary healthcare information computing system environment 100 includes a general purpose computing device in the form of a control server 102. Components of the control server 102 may include, without limitation, a processing unit, internal system memory, and a suitable system bus for coupling various system components, including database cluster 104, with the control server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and non-removable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the control server 104.

The control server 102 may operate in a computer network 106 using logical connections to one or more remote computers 108. Remote computers 108 may be located at a variety of locations in a medical, healthcare, or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, clinicians' offices, any clinical-trial locations, a clinical-trial sponsor location, and/or the like. Clinicians may include, but are not limited to, a treating physician or physicians, specialists such as surgeons, radiologists, cardiologists, oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 108 may also be physically located in non-traditional healthcare care environments so that the entire health care community may be capable of integration on the network. The remote computers 108 may be personal computers, servers, routers, network PCs, peer devices, other common network nodes, or the like, and may include some or all of the elements described above in relation to the control server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the control server 102 may include a modem or other means for establishing communications over the WAN, such as the Internet. In a networked environment, program modules or portions thereof may be stored in the control server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) may be utilized.

In operation, a user may enter commands and information into the control server 102 or convey the commands and information to the control server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 102. In addition to a monitor, the control server 102 and/or remote computers 108 may include other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 102 and the remote computers 108 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting clinical trials. As contemplated by the language above, the methods and systems of embodiments of the present invention may also be implemented on a stand-alone desktop, personal computer, or any other computing device used in a healthcare environment or any of a number of other locations.

As previously mentioned, embodiments of the present invention relate to computerized methods and systems for use in, e.g., a clinical-trial environment, for facilitating clinical-trial referrals. A clinical-trial referral, as used herein, refers to any referral, recommendation, or suggestion of an individual (patient) for a particular clinical trial. In this way, an individual can be notified that he or she may be an acceptable, appropriate, eligible, qualified, or potential individual to participate in a specific clinical trial. A clinical trial, as used herein, refers to a clinical test performed on a set of one or more human subjects. A clinical trial might be a controlled test of a new drug, a new medical device, a new medical procedure, and/or the like performed on individuals prior to release for general clinical use. For example, a clinical trial might be a scientific investigation of a new treatment that has shown benefit in animal or laboratory studies, but that has not yet been proven effective in humans. (The terms “individual”, “person”, and “patient” are used interchangeably herein and are not meant to limit the nature of the referenced individual in any way. Rather, the methods and systems described herein are equally applicable, for instance, in a veterinary setting. Further, use herein of the term “patient” is not meant to imply any particular relationship between the individual in question and those facilitating clinical trials or providing care.)

Embodiments of the present invention include various aspects of facilitating clinical-trial referrals. For example, some embodiments are directed to providing a patient, or a clinician associated therewith, an indication of one or more clinical trials in which the patient is eligible to participate. Recognizing and providing clinical trials available to a patient, or potentially available to a patient, might provide an opportunity for the patient to participate in a clinical trial that may otherwise be unknown to the patient. Accordingly, a patient may be able to participate in a clinical trial in an effort to treat a health condition. Further, providing available clinical trials to patients can result in an increase in the number of participants in clinical trials. In another example, other embodiments are directed to providing a clinical-trial provider with details regarding a clinical trial (e.g., an ongoing clinical trial) to assist in increasing the number of available participants and/or improving the success of the clinical trial. To this end, indications of possible criteria modifications can be provided that, if implemented, can result in an increase in the number of possible participants in a clinical trial.

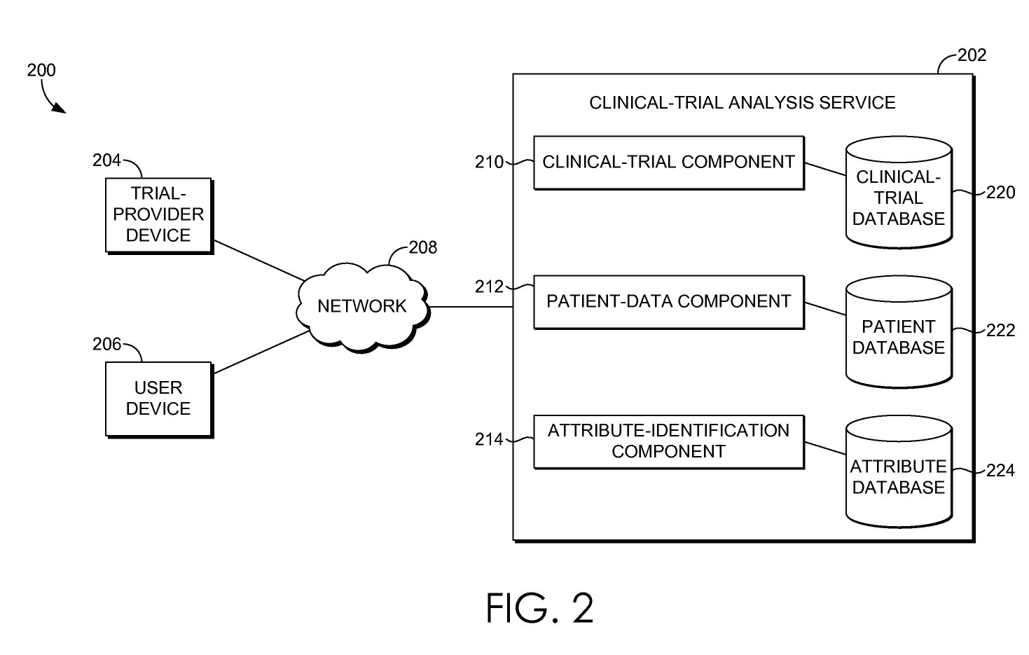

With reference to FIG. 2, an exemplary system suitable for use in implementing embodiments of the present invention is shown and designated generally as reference numeral 200. In embodiments, system 200 includes a clinical-trial analysis service 202, a trial-provider device 204, and a user device 206 in communication with one another through a network 208. The clinical-trial analysis service 202 can alternatively be referred to as a CTRE or Clinical Trial Referral Engine. The network 208 may include, without limitation, one or more local area networks (LANs) and/or wide area networks (WANs). The network 208 may include multiple networks, as well as being a network of networks, but is shown in a more simple form so as to not obscure other aspects of the present invention. Such networking environments are commonplace in offices, enterprise-wide computer networks, intranets, and the Internet. Accordingly, the network 208 is not further described herein.

In embodiments, the clinical-trial analysis service 202 includes a clinical-trial component 210, a patient-data component 212, and an attribute-identification component 214. In some embodiments, one or more of the illustrated components may be implemented as stand-alone applications. In other embodiments, one or more of the illustrated components may be integrated directly into the operating system of the control server 102, a cluster of servers 104, and/or the remote computers 108 of FIG. 1. For example, the clinical-trial component 210, the patient-data component 212, and the attribute-identification component 214 might be implemented as part of the controller server 102 of FIG. 1, while the user device 206 and trial-provider device 204 might be represented by a remote computer 108 of FIG. 1. It will be understood that the components illustrated in FIG. 2 are exemplary in nature and in number and should not be construed as limiting. Any number of components may be employed to achieve the desired functionality within the scope of embodiments herein. Further, components may be located on any number of servers or computing devices.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The clinical-trial component 210 is configured to obtain and/or provide clinical-trial data. Such clinical-trial data can be used to identify clinical-trial attributes that can be provided to clinicians, patients, and/or clinical-trial providers to facilitate clinical-trial referrals.

Initially, the clinical-trial component 210 obtains clinical-trial data. Such clinical trial data can be received, retrieved, or otherwise obtained. Clinical-trial data can be input, for example, via any user, clinical-trial provider, or device associated therewith. By way of example only, clinical-trial data can be input by a clinical-trial provider via the trial-provider device 204 that is remote from the clinical-trial analysis service 202. A clinical-trial provider, as used herein, refers to any provider, sponsor, organizer, or representative of a clinical trial. For instance, a clinical-trial provider may be a pharmaceutical company, a medical device company, a university or other medical facility, a clinician or set of clinicians, or any other entity, individual, set of individuals, or representative thereof, that coordinates, executes, or otherwise facilitates a clinical trial. In this way, a clinical-trial provider may provide administrative support, financial support, and/or healthcare support for a clinical trial.

Clinical-trial data (CT data) refers to any data that indicates or describes a clinical trial, or criteria associated therewith. By way of example only, clinical-trial data may be a clinical-trial identifier, a clinical-trial criterion, a criteria parameter, or other data describing or indicating a clinical trial. A clinical-trial identifier provides a unique identification or indication of a particular clinical trial. For example, a clinical-trial identifier might identify a clinical trial related to sleep apnea that is facilitated at a first clinical site.

A clinical-trial criteria (CT criteria) refers to a criteria or rule for applying or associating an individual with a clinical trial. “Criteria,” as used herein, is generally used to refer to one or more criteria. A CT criteria may include any data that facilitates application, qualification, or eligibility of an individual with a clinical trial. In embodiments, a CT criteria can include a criteria element that indicates or identifies an item or component to which the CT criteria is directed. For example, a criteria element may refer to a weight, a height, a BMI (body mass index), a gender, a particular medication, a particular medical condition, a particular lab result, a particular surgical procedure, etc. associated with a patient. A CT criteria can also include a criteria value associated with a criteria element that can be any value including, but not limited to, a threshold, a maximum value, a minimum value, a range of values (e.g., discrete or continuous), a selected value(s), or any other value that indicates the scope of a criteria element. For example, a value associated with a criteria element of weight might be greater than 200 pounds, less than 200 pounds, a range of 200 to 300 pounds, an indication of “yes” a patient weighs more than 200 pounds, or the like. By way of another example, a value associated with a criteria element of usage of a particular drug might be no usage within 3 months, “no” never used, minimal usage within one year, or the like.

A criteria parameter refers to context associated with a particular CT criteria. As such, a criteria parameter indicates a manner for applying a clinical-trial criteria. Without limitation, examples of a criteria parameter include an exclusion criteria, an inclusion criteria, a required criteria, and an optional criteria. A criteria parameter might designate a particular criteria as an exclusion criteria or an inclusion criteria. An exclusion criteria refers to a criteria that excludes an individual from a clinical trial. In other words, an individual is excluded from a clinical trial if the corresponding clinical criteria is not met. An inclusion parameter refers to a criteria that includes an individual to a clinical trial. That is, the corresponding clinical criteria is to be met for a person to be included in a clinical trial. By way of example only, assume that a weight above 200 pounds is an exclusion criteria for a particular clinical trial. In such a case, an individual having a weight over 200 pounds is an excluded candidate of the clinical trial and, as such, will not be referred to the particular clinical trial. On the other hand, assume that a weight above 200 pounds is an inclusion criteria for a particular clinical trial. In such an instance, the same individual that weighs over 200 pounds is a candidate for the clinical trial at least in association with that particular criteria.

In some cases, a criteria parameter might additionally or alternatively be a required criteria or an optional criteria. A criteria parameter might designate a particular criteria as a required criteria or an optional criteria. A required criteria indicates that a particular CT criteria is required. An optional parameter indicates that a particular CT is optional or recommended, but not required. By way of example only, assume that a weight above 200 pounds is required for participation in a particular clinical trial. In such a case, an individual having a weight below 200 pounds is a not a potential candidate of the clinical trial. On the other hand, assume that a weight above 200 pounds is optional for participation in a particular clinical trial. In such an instance, the same individual that weighs under 200 pounds can remain a candidate for the clinical trial (although may not ultimately be considered a potential candidate based on failure to meet another criteria).

Other clinical-trial data may include, but is not limited to, an indication of a geographical region for a clinical trial (e.g., a city/state, a zipcode, etc.); a location for a clinical trial; a date a clinical trial begins; a date associated with establishment of clinical trial criteria; a date range for an active clinical trial; a source for clinical trial information (e.g., a URL that, if linked to or otherwise accessed, provides details regarding a clinical trial); other details regarding a clinical trial; and/or the like.

Further, individual organizations, clinical-trial providers, or the like may have individual clinical-trial data, such as CT criteria, that are used to identify clinical-trial attributes and, thus, may establish and provide unique clinical-trial data to detect appropriate clinical-trial attributes. For instance, a first medical organization may use a weight criteria of above 200 pounds to indicate an individual is appropriate for a first clinical trial, while a second medical organization may use a weight criteria of above 250 pounds to indicate an individual is appropriate for a second clinical trial that is similar to the first clinical trial. In the instance a patient weighs 225 pounds, the first medical organization may recognize the patient as qualified for the first clinical trial, while the second medical organization does not recognize the patient as qualified for the second clinical trial. Accordingly, as clinical-trial criteria can be designated by and specific to a client in some embodiments, clinical-trial criteria can be obtained in association with a client (or set of users) and stored in accordance with the client (e.g., clinical-trial provider, clinical-trial site, etc.).

Clinical-trial data can be stored, for example, via a clinical-trial database 220. The database 220 is configured to store information associated with at least one clinical trial. In various embodiments, such information may include, without limitation, a clinical-trial identifier; one or more clinical-trial criteria defining required, desired, or optional elements or items and/or one or more values (e.g., numerals, lab result, test result, etc.) associated with a criteria item; a criteria parameter (e.g., exclusion, inclusion, required, optional, etc.); other clinical-trial data, and/or the like. In embodiments, the database 220 is configured to be searchable for one or more clinical-trial data stored in association therewith. The database 220 can be a centralized database (e.g., in the cloud) that aggregates clinical-trial data provided by a plurality of remote sources. For example, a representative of a first clinical-trial site may provide clinical-trial data associated with the first clinical-trial site (e.g., via a web interface), and a representative of a second clinical-trial site may provide clinical-trial data associated with the second clinical-trial site (e.g., via the web interface). Both sets of such clinical-trial data can be collected and stored in database 220 for subsequent reference to identify clinical-trial attributes.

It will be understood and appreciated by those of ordinary skill in the art that the information stored in the database 220 may be configurable and may include any information relevant to a clinical trial(s). The content and volume of such information are not intended to limit the scope of embodiments of the present invention in any way. Further, though illustrated as a single, independent component, database 220 may, in fact, be a plurality of databases, for instance, a database cluster, portions of which may reside, for example, on a computing device associated with the clinical-trial component 210, the patient-data component 212, the attribute-identification component 214, the trial-provider device 204, the user device 206, a cloud-computing platform, another external computing device, and/or any combination thereof. As can be appreciated, the data discussed in relation to database 220 may be aggregated and combined with the described data stored in database 222 and/or database 224.

Clinical-trial data can be accessible by any component, such as the clinical-trial component 210, the patient-data component 212, the attribute-identification component 214, the trial-provider device 204, the user device 206, a cloud-computing platform, another external computing device, and/or any combination thereof. For example, and as described more fully below, the attribute-identification component 214 might access clinical-trial data to facilitate identifying clinical-trial attributes.

The patient-data component 212 is configured to obtain and/or provide patient data. Such patient data can be utilized to identify clinical-trial attributes that can be provided to clinicians, patients, and/or clinical-trial providers to facilitate clinical-trial referrals.

Initially, the patient-data component 212 obtains patient data. Such patient data can be received, retrieved, or otherwise obtained. Patient data can be input, for example, via any user (e.g., clinician or patient) or user device. By way of example only, patient data can be input into a clinician application using user device 206 to record health or medical data regarding a patient. As another example, patient data can be input by the patient, for example, using a patient application to record health or medical data regarding the patient. As can be appreciated, patient data can be obtained from any number of sources. For example, some patient data may be obtained upon a clinician entering such data into a clinical application in accordance with a clinical encounter while other patient data is obtained from a database storing historical patient data (e.g., via a patient EHR (electronic health record), a CCD (continuity of care document), etc.).

Patient data can be any health or medical-related data associated with a patient or any data that identifies or describes a patient. By way of example only, patient data may include a patient identifier, a date of birth, demographic information (e.g., race, age, gender, etc.), a diagnoses, a health condition(s), a laboratory result(s), a symptom(s), an active medication(s), a historic medication(s), a social history (e.g., smoking, alcohol consumption), a patient address, a distance from a patient's home to a clinical-trial site, or any other information relevant or related to the patient that can be used to determine whether a patient qualifies for a clinical trial(s).

Obtained patient data can be stored, for example, via a patient database 222. The database 222 is configured to store information associated with at least one patient or individual. In various embodiments, such information may include, without limitation, a patient identifier (e.g., name or other identifier), a date of birth, demographic information (e.g., race, age, gender, etc.), a diagnoses, a health condition(s), a laboratory result(s), a symptom(s), an active medication(s), a historic medication(s), a social history (e.g., smoking, alcohol consumption), a patient address, a distance from a patient's home to a clinical trial site, or any other information relevant or related to the patient that can be used to determine whether a patient qualifies for a clinical trial(s). In embodiments, the database 222 is configured to be searchable for one or more patient data. The database 222 can be a centralized database (e.g., in the cloud) that aggregates patient data provided by a plurality of remote sources. For example, a first clinician of a first medical facility may provide patient data associated with a first point of care visit (e.g., via a web interface), and a second clinician of a second medical facility may provide patient data associated with a second point of care visit (e.g., via the web interface). Both sets of such patient data can be collected and stored in database 222 for subsequent reference to identify clinical-trial attributes.

It will be understood and appreciated by those of ordinary skill in the art that the information stored in the database 222 may be configurable and may include any information relevant to a patient. The content and volume of such information are not intended to limit the scope of embodiments of the present invention in any way. Further, though illustrated as a single, independent component, database 222 may, in fact, be a plurality of databases, for instance, a database cluster, portions of which may reside, for example, on a computing device associated with the clinical-trial component 210, the patient-data component 212, the attribute-identification component 214, the trial-provider device 204, the user device 206, a cloud-computing platform, another external computing device, and/or any combination thereof. As can be appreciated, the data described in relation to database 222 may be aggregated and combined with the described data stored in database 220 and/or database 224. In some embodiments, patient data does not persist in the patient database 222. Rather, the patient data is used for screening on the clinical trial data and, thereafter, is discarded. Such an implementation can minimize or alleviate security concerns and HIPAA concerns regarding patient data.

The patient data can be accessible by any component, such as the clinical-trial component 210, the patient-data component 212, the attribute-identification component 214, the trial-provider device 204, the user device 206, a cloud-computing platform, another external computing device, and/or any combination thereof. For example, and as described more fully below, the attribute-identification component 214 might access (e.g., receive or retrieve) patient data to determine any clinical-trial attributes.

The attribute-identification component 214 is configured to identify clinical-trial attributes (CT attributes) associated with clinical trials. In this regard, the attribute-identification component 214 is configured to determine, identify, recognize, or detect clinical-trial attributes. A clinical-trial attribute refers to any attribute associated with a clinical trial that facilitates clinical-trial referrals.

In embodiments, a clinical-trial attribute can be a patient-related attribute or a trial-related attribute. A patient-related attribute refers to any attribute or information associated with a clinical trial or set of clinical trials that is specific to a patient. In this regard, a patient-related attribute provides information that is related or relevant to a specific patient regarding a clinical trial(s). In embodiments, patient-related attributes are identified upon a request to initiate a clinical-trial analysis or screen a specific patient for one or more clinical trials. Screening a patient refers to considering or determining whether the patient is eligible, acceptable, a match, or a potential match for one or more clinical trials. Initiating a clinical-trial analysis or a screening of a patient can be initiated, for example, by a clinician or other user (e.g., patient) selecting to view clinical trials available for a patient. Initiating such a screening can be logged.

A patient-related attribute may be, for example, an indication of a clinical trial in which a patient may potentially participate (e.g., via a clinical-trial identifier). In some cases, a patient may potentially participate in a particular clinical trial when patient data corresponds, matches, or aligns with CT criteria associated with the clinical trial so that the patient is considered qualified or eligible for the clinical trial. To this end, in embodiments, a clinical trial is identified as a clinical trial for a patient if the inclusion criteria result in a true value and the exclusion criteria result in a false value when compared to the patient data. In other words, each of the required clinical-trial criteria is met or matched by patient data associated with the patient.

In other cases, a patient may potentially participate in a clinical trial when patient data nearly corresponds, aligns, or matches CT criteria associated with the clinical trial (e.g., within a threshold or range). In such cases, a patient may not be presently eligible for a clinical trial, but with a minor change in patient data, may become eligible for the clinical trial. For example, patient data that has a minor variation in scope from CT criteria may result in a potential clinical trial for the patient. Such a variance may be based on thresholds, percents, or other measures, for example, designated by a clinical-trial provider, an administrator, etc. Such potential clinical trials may be identified and provided to the patient so that the patient is aware of possible clinical trials in which the patient may participate, for example, in an instance a patient would like to relocate to be accessible for the clinical trial, in an instance the date of the clinical trial is modified, in an instance a medical or health data changes for the individual, etc.

Another patient-related attribute may be a match score. A match score can be any value (e.g., numerical value, a percent, textual indicator, etc.) to indicate an extent of a relationship between the patient data and clinical-trial data associated with a clinical trial. In this regard, a match score indicates a degree of strength of a patient's eligibility for a particular clinical trial. By way of example only, a match score might be a numerical value (e.g., 10), a percent (80%), a textual indicator (e.g., strong), an icon, or other symbol. A match score may be calculated based on a number or extent of required criteria and/or optional criteria that are met by a patient. For instance, assume that a clinical trial is associated with ten criteria. A patient that meets each of the ten criteria may be given a score of 100% or “strong” while a patient that meets eight of the ten criteria may be given a score of 80% or “moderate” strength.

In embodiments, a match score may be determined utilizing weights. For example, a weight can be assigned (e.g., via a clinical-trial provider) to each CT criteria (e.g., a component representing a CT criteria). In analyzing the patient data in accordance with the CT criteria, the weights associated with each criteria can be used to calculate a total match score for a clinical trial. By way of example only, a higher weight may be associated with required criteria than weights associated with optional criteria. In another example, a higher weight may be associated with criteria deemed more important to the clinical trial than criteria deemed less important to the clinical trial.

Match scores can be calculated for any number of clinical trials. In some cases, a match score for a patient might be calculated for each available clinical trial. In other cases, a match score might be calculated for a portion of available clinical trials, such as, for example, clinical trials associated with a particular medical condition, clinical trials associated with a specific patient data (e.g., age, gender, residence, etc.), clinical trials being administered within a particular geographical region, clinical trials that are deemed matches for a patient (e.g., clinical trials for which a patient meets all of the required criteria), clinical trials that are deemed near matches for a patient (e.g., clinical trials for which a patient meets a specific portion of the required criteria), or the like. Such match scores can be used to rank clinical trials for which a patient is eligible or is potentially eligible.

By way of example only, assume that a first clinical trial requires an age of 20-30 years of age, a weight of over 250 pounds, and a medical condition of diabetes and also includes an optional criteria that prefers non-smokers. Further assume that a second clinical trial requires an age of 20-30, a weight of over 250 pounds, and a medical condition of diabetes, but does not include any optional criteria. A diabetic patient that is 25 years of age with a weight of 275 pounds and that habitually smokes may receive a higher match score for the second clinical trial that does not have any smoking preferences.

In embodiments, patient-related attributes can also include any other attributes related to screening a patient to identify any applicable clinical trials. For example, to identify one or more clinical trials for which the patient may be eligible or is eligible and/or to identify corresponding match scores, criteria associated with the clinical trials is evaluated in accordance with patient data. In this way, such patient-related attributes may include, for example, a success or failure for criteria associated with a clinical trial (e.g., each criteria associated with a clinical trial is evaluated to determine whether the patient satisfies the criteria), an indication of a variation from a criteria associated with a clinical trial (e.g., 10 pounds under a weight criteria, 1% variance from a BMI criteria, etc.), an indication of a number of success and/or failure criteria (e.g., patient A satisfied 5 of the criteria or 50% of the criteria), or the like.

To determine a patient-related attribute, the attribute-identification component 214 can reference patient data and/or clinical-trial data. Such patient data can be received, retrieved, or otherwise accessed to identify patient-related attributes. In some cases, a patient identifier indicating a particular patient can be provided such that patient data associated therewith is referenced. As can be appreciated, patient data can be referenced from a database, such as patient database 222, or can be referenced from data input into a clinical application. For instance, patient data may be input into a clinical application via a computing device (e.g., user device 206) and, thereafter, referenced by the attribute-identification component 214. By way of example only, during a clinical encounter, a clinician may input health data pertaining to a patient, which can be received and referenced (e.g., via a clinician user interface) along with other patient data related to the patient that is stored in a patient database (e.g., patient data from an electronic health record for the patient).

Clinical-trial data can also be referenced to identify clinical-trial attributes associated with a clinical trial(s). In some cases, a clinical-trial identifier indicating a particular clinical trial may be provided such that clinical-trial data associated therewith is referenced. In other cases, clinical-trial data associated with multiple clinical trials may be referenced, for example, to identify any clinical trials acceptable or suggested for a patient. In such a case, a number of clinical-trial identifiers can be provided to reference clinical-trial data associated therewith (e.g., clinical trials associated with a particular geographic region, clinical trials associated with a particular health condition, etc.), or, alternatively, all clinical trial data may be accessed. In some embodiments, specific clinical-trial data to reference may correspond with a clinical trial associated, for example, with a particular health condition, a particular geographic region, a particular demographic, etc.

In embodiments, patient data and/or clinical-trial data can be referenced upon receiving an indication to identify or provide patient-related attributes, such as, for example, available clinical trials for a patient, any available clinical trials for a patient related to a particular medical condition, or the like. Accordingly, a clinician may select “find clinical trials” or provide another indication that seeks clinical trials available to a patient or that screens the patient for any clinical trials available to the patient. Such an indication can be provided using any method, such as a tab, a link, a button, etc. Alternatively, referencing patient data and/or clinical trial data can be automatically initiated (e.g., upon a patient selection, etc.).

The patient data can be compared to the clinical-trial data to identify any patient-related attributes. In this way, the attribute-identification component 214 compares patient data associated with a patient to clinical-trial data associated with one or more clinical trials to identify clinical-trial attributes.

To identify patient-related attributes, the attribute-identification component 214 can search or scan clinical-trial data (e.g., associated with active or prospective clinical trials) to determine or identify for which clinical trials a particular patient may be or is eligible. As such, a set of clinical-trial data related to one or more clinical trials is searched to determine if a patient meets criteria set forth for the clinical trial(s). In one embodiment, the attribute-identification component 214 searches a centralized database having clinical-trial data associated with a plurality of clinical trials. For example, a centralized database storing clinical-trial criteria for numerous clinical trials geographically dispersed can be searched or scanned.

In an implementation that identifies clinical trials for which an exact match to criteria is required, the patient data is analyzed in light of the required criteria to identify that a patient is a “match” for a particular clinical trial(s). Accordingly, the patient data indicates that an individual appropriately conforms to all required exclusion criteria and appropriately conforms to all required inclusion criteria. That is, the patient meets the criteria required to be included in a clinical trial and is not associated with any criteria that would exclude the patient from the trial. Further, a match score may be calculated for the clinical trials, for example, to distinguish clinical trials having optional criteria, to distinguish clinical trials having varying weights associated with criteria, or the like.

In an implementation that also identifies clinical trials that are not an exact match (e.g., a patient meets most, but not all, of criteria associated with a clinical trial), the patient data is analyzed in light of the criteria and/or a match score or an indication of a criteria not met can be identified. By way of example only, assume that potential clinical trials for which a patient is a near match are desired to be provided for the patient. Upon receiving an indication to provide potential clinical trials that are appropriate for the patient, patient data corresponding to the patient is compared to clinical-trial criteria to identify one or more clinical trials that the patient may qualify for based on the clinical-trial criteria. Clinical trials for which the patient is currently eligible may be presented as such, while clinical trials for which the patient is nearly eligible or might be eligible in the future may be presented accordingly.

Further, in some embodiments, other patient-related attributes can be identified, for example, in determining or identifying for which clinical trials a particular patient may be eligible. By way of example only, other such patient-related attributes may include a success or failure for criteria associated with a clinical trial, an indication of a variation from a criteria associated with a clinical trial (e.g., 10 pounds under criteria, 1% variance from criteria, etc.), an indication of a number of success and/or failure criteria of a clinical trial, or the like. Such patient-related attributes may be provided to a user, such as a clinician or a patient, and/or may be stored and utilized to identify trial-related attributes, as described more fully below.

A trial-related attribute refers to any attribute or information that is specific to a clinical trial. In this regard, a trial-related attribute provides information that is related or relevant to a specific clinical trial(s). A trial-related attribute may be, for example, an indication of patients that are eligible for a clinical trial, an indication of patients that are potentially a match for a clinical trial, an indication of patient match scores associated with a clinical trial, a distribution of patient match scores associated with a clinical trial, an indication of criteria that have a most frequent or strongest effect on match scores associated with a clinical trial, an indication of most frequent failure or success criteria of eligibility for a clinical trial, an indication of a criteria that is most frequently absent (e.g., for optional criteria) for a clinical trial, an indication of a distribution of patient data related to a criteria, an indication of a criteria to modify for a clinical trial, an indication of a value for modifying a criteria associated with a clinical trial, an estimated impact or result that might occur upon performing a recommended criteria modification associated with a clinical trial, or the like.

To identify trial-related attributes, in one embodiment, the attribute-identification component 214 can analyze clinical-trial data associated with a particular clinical trial in light of patient data. The trial-related attributes are particular to a clinical trial and, accordingly, pertinent to an aggregate or plurality of patients. A clinical-trial identifier associated with a clinical trial to analyze may be utilized to reference clinical-trial data associated with the clinical-trial identifier.

In such an embodiment, the attribute-identification component 214 can reference patient data and/or clinical-trial data. Such patient data can be received, retrieved, or otherwise accessed to identify patient-related attributes. As can be appreciated, patient data can be referenced from a database, such as patient database 222, or can be referenced from data input into a clinical application. For instance, patient data may be input into a clinical application via a computing device (e.g., user device 206) and, thereafter, referenced by the attribute-identification component 214. By way of example only, during a clinical encounter, a clinician may input health data pertaining to a patient, which can be received and referenced along with other patient data related to the patient that is stored in a patient database (e.g., patient data from an electronic health record for the patient).

Patient data associated with a particular patient or set of patients to reference can be identified in any manner. For example, in one embodiment, patient data of patients associated with a particular medical condition, a particular geographic region, a particular demographic (e.g., age, gender, etc.), or other health data might be referenced. In another embodiment, patient data associated with patients that have been screened for the particular clinical trial may be referenced. In this regard, patient data associated with each patient that a user, such as a clinician, selects to screen might be referenced. In some cases, a patient may be screened for any available clinical trial. In other cases, a patient may be screened for a particular portion of clinical trials (e.g., clinical trials associated with a medical condition, clinical trials associated with a geographic region, clinical trials associated with a particular demographic, a combination thereof, or the like).

Clinical-trial data can be referenced to identify clinical-trial attributes associated with a clinical trial(s). In some cases, a clinical-trial identifier indicating a particular clinical trial may be provided such that clinical-trial data associated therewith is referenced. In other cases, clinical-trial data associated with multiple clinical trials may be referenced, for example, to compare data for various clinical trials. In such a case, a number of clinical-trial identifiers can be provided to reference clinical-trial data associated therewith (e.g., clinical trials associated with a particular geographic region, clinical trials associated with a particular health condition, clinical trials at various sites administered by a common clinical-trial provider, etc.), or, alternatively, all clinical trial data may be accessed.

In embodiments, patient data and/or clinical-trial data can be referenced upon receiving an indication to identify or provide trial-related attributes, such as, for example, suggestions for criteria modifications. For example, a clinical-trial provider may select “clinical trial report” or provide another indication that seeks information related to a clinical trial(s). Such an indication can be provided using any method, such as a tab, a link, a button, etc. Alternatively, referencing patient data and/or clinical trial data can be automatically initiated (e.g., upon a clinical-trial site selection, etc.).

The patient data can be compared to the clinical-trial data to identify any trial-related attributes. In this way, the attribute-identification component 214 compares patient data associated with one or more patients to clinical-trial data to identify trial-related attributes. By way of example, the attribute-identification component 214 can search or scan patient data (e.g., associated with one or more patients) to determine or identify information pertaining to a clinical trial. As such, a set of patient data is searched to determine if one or more patients meet criteria set forth for the clinical trial. In one embodiment, the attribute-identification component 214 searches a centralized database having patient data associated with a plurality of patients. Any amount of patient data may be used to identify the trial-related attributes.

In another embodiment used to identify trial-related attributes, the attribute-identification component 214 can additionally or alternatively utilize patient-related attributes. Accordingly, data previously determined, for example, during a patient screening, can be utilized such that the patient data is less likely required to be analyzed again in light of clinical-trial data. As previously described, in one implementation, incoming requests for patient-related attributes can be logged (i.e., screening requests). In other words, incoming requests to screen a patient for possible participation in a clinical trial(s) can be recorded. Such logged requests may be initiated by any number of clinical-trial sites. Further, the patient-related attributes, such as criteria satisfied by the patient, clinical trials that are identified as a match for the patient, success or failure for criteria associated with a clinical trial, an indication of a variation from a criteria associated with a clinical trial, an indication of a number of success and/or failure criteria, etc., can also be logged. As previously described, such attributes may be recognized in identifying clinical trials available to the patient. Such a set of patient-related attributes can then be utilized to identify various trial-related attributes.

Accordingly, a clinical-trial report can efficiently be generated using patient-related attributes determined in association with previous patient screenings. That is, patient-related attributes associated with patients previously screened for clinical trials can be aggregated or summarized to determine and provide trial-related attributes. By way of example only, assume a first patient is screened for any clinical trials associated with lung cancer within a particular geographical region. Accordingly, the patient is screened for a first lung cancer clinical trial resulting in a first set of patient-related attributes. Further assume that a second patient is also screened for the first lung cancer clinical trial resulting in a second set of patient-related attributes. In such a case, the first set of patient-related attributes for the screening of the first patient can be aggregated with the second set of patient-related attributes for the screening of the second patient. In this way, various trial-related attributes associated with the clinical trial can be identified. Accordingly, success or failure of each criteria associated with a particular clinical trial can be monitored to determine which criteria were the most frequent failure or success points of eligibility, the most frequent close calls, data that is most frequently absent (for optional fields). For each clinical trial, a clinical-trial report summarizing the impact factor of each criterion can be provided on a regular basis or upon request. The contents of this report can be formatted in accordance with each participating site, allowing the clinical-trial sponsor to determine whether recruitment failures are systemic (common across sites) or localized. As such a clinical-trial report can enable an impact of each criteria to be tracked, an impact of criteria categories (e.g., medications, labs, diagnoses, etc.) to be tracked, a comparison of single sites to overall group of participating sites to be monitored, etc. Based on tracking or monitoring clinical-trial criteria successes, failures, and/or variances, suggestions of clinical-trial criteria to modify and expected results associated therewith can be provided, for example, in the clinical-trial report.

For instance, assume that an analysis or report of a clinical trial is desired. Upon receiving an indication to provide a clinical-trial report, patient data associated with a plurality of patients and/or patient-related attributes are analyzed in light of the clinical-trial data to identify attributes associated with the clinical trial. In this regard, attributes such as possible criteria modifications can be identified and presented to the user along with corresponding results that might occur if modifications are applied.

Clinical-trial attributes can be stored, for example, via an attribute database 224. The database 224 is configured to store information associated with at least one clinical-trial attribute. In various embodiments, such information may include, without limitation, patient-related attributes, trial-related attributes, and the like. In embodiments, the database 224 is configured to be searchable for one or more items or values stored in association therewith. In embodiments, the database 224 is configured to be searchable for one or more clinical-trial attributes. The database 222 can be a centralized database that aggregates clinical-trial data. Clinical-trial attributes can be collected and stored in database 222 for subsequent reference.

It will be understood and appreciated by those of ordinary skill in the art that the information stored in the database 224 may be configurable and may include any information relevant to a clinical-trial attribute. The content and volume of such information are not intended to limit the scope of embodiments of the present invention in any way. Further, though illustrated as a single, independent component, database 224 may, in fact, be a plurality of databases, for instance, a database cluster, portions of which may reside, for example, on a computing device associated with the clinical-trial component 210, the patient data component 212, the attribute-identification component 214, the user computing device, a cloud-computing platform, on another external computing device, and/or any combination thereof. Alternatively, the data described in relation to database 224 may be aggregated and combined with the described data stored in database 220 and/or database 222. For example, in some embodiments, clinical-trial attributes, such as patient-related attributes, can be stored in association with a patient, for instance, using patient database 222.

Upon determining clinical-trial attributes, the attribute-identification component 214 can provide such attributes to any computing device(s) for presentation to a user(s). Accordingly, in embodiments, clinical-trial attributes are returned to a computing device and/or user that provided a request for information. To this end, a clinician providing a request for clinical trials in which a patient may participate can be provided with any potential clinical trials in which the patient may participate. In other cases, a clinical-trial provider providing a request for a clinical-trial report can be provided with data that summarizes, describes, or otherwise provides information associated with a particular clinical trial.

As can be appreciated, clinical-trial attributes can be presented to users in any manner, some of which will be described in more detail below. Further, other data, such as corresponding patient data and/or clinical-trial data, may also be provided to users. For example, in addition to providing patient-related attributes to a clinician or patient, clinical-trial data can be provided to identify or provide details regarding clinical trials. Such clinical-trial data may include a date or date range of the clinical trial, a location of the clinical trial, contact information for the clinical trial, a source of information for the clinical trial (e.g., a URL that, if linked to, provides clinical trial details), or other details regarding the clinical trial. Such details may be referenced (e.g., received or retrieved), for example, from the clinical-trial component 210 or database 220 associated therewith.

As previously mentioned, the system 200 further includes a trial-provider device 204 in communication with the clinical-trial analysis service via the network 208. The trial-provider device 204 may be associated with any type of computing device, such as computing device 100 described with reference to FIG. 1, for example. Such trial-provider device 204 can be operated, for instance, by a clinical-trial provider, such as a representative of a pharmaceutical company. Though not shown in FIG. 2, the trial-provider device 204 typically includes at least one presentation module configured to present (e.g. display) one or more clinical-trial attributes. For example, the trial-provider device 206 can display trial-related attributes specific to a particular clinical trial, such as an indication of failure or success of clinical-trial criteria, an indication of patient close calls relative to clinical-trial criteria, an indication of patient data absent for clinical-trial criteria, an indication of a suggested criteria modification, an indication of an expected outcome for application of a suggested criteria modification, an indication or a distribution of patient data associated with criteria, or the like. Such embodiments are more fully described herein below. Further, the trial-provider device 204 can include an input module configured to receive input. Typically, input is input via a user interface (not shown) associated with the end-user device, or the like. For example, a clinical-trial provider may input an indication to view a clinical-trial report or clinical-trial attributes and/or may input clinical-trial data.

The system 200 further includes a user device 206 in communication with the clinical-trial analysis service via the network 208. The user device 216 may be associated with any type of computing device, such as computing device 100 described with reference to FIG. 1, for example. Such a user device can be operated, for instance, by a clinician, a patient, etc. Though not shown in FIG. 2, the user device 206 typically includes at least one presentation module configured to present (e.g. display) one or more clinical-trial attributes. For example, the user device 206 can display one or more clinical trials that are available to a patient. Such embodiments are more fully described herein below. Further, the user device 206 can include an input module configured to receive input. Typically, input is input via a user interface (not shown) associated with the end-user device, or the like. For example, a user may input an indication to view one or more clinical trials for which a patient is eligible to participate and/or may input patient data.

Additionally, other components not shown may also be included with the system 200. Further, additional components not shown may also be included within any of the clinical-trial analysis service 202, the trial-provider device 204, and the user device 206. Any and all such variations are contemplated to be within the scope of embodiments hereof.

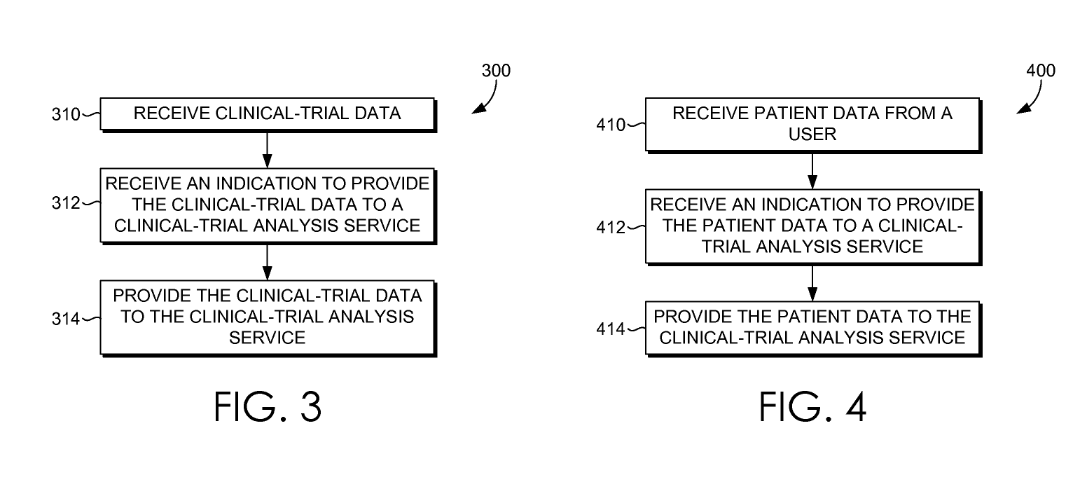

Turning now to FIG. 3, a flow diagram showing a method for providing clinical-trial data, in accordance with an embodiment of the present invention, is illustrated and designated generally as reference numeral 300. Method 300 may be implemented on the above-described exemplary computing system environment (FIG. 2) and, by way of example only, may be utilized by a clinical-trial provider to provide clinical-trial data including clinical-trial criteria.

Initially, at block 310, clinical-trial data is received. Clinical-trial data may be received, for example, based on input from a clinical-trial provider. For each clinical trial, clinical-trial data input may be, but is not limited to, a clinical-trial identifier, one or more clinical-trial criteria, and one or more clinical-trial parameters. At block 312, an indication to provide the clinical-trial data to a clinical-trial analysis service is received. Thereafter, at block 314, the clinical-trial data is provided to the clinical-trial analysis service, such as clinical-trial analysis service 202 of FIG. 2. The clinical-trial data can be provided to the clinical-trial analysis service, for example, via a web-based interface (e.g., Representational State Transfer (REST) interface). Such clinical-trial data might be provided to a clinical-trial component 210 of FIG. 2 for storage in the clinical-trial database 220 of FIG. 2.

Turning now to FIG. 4, a flow diagram showing a method for providing patient data, in accordance with an embodiment of the present invention, is illustrated and designated generally as reference numeral 400. Method 400 may be implemented on the above-described exemplary computing system environment (FIG. 2) and, by way of example only, may be utilized by a clinician to provide patient data.

Initially, at block 410, patient data is received from a user, such as the patient or a clinician providing services to the patient. At block 412, an indication to provide the clinical-trial data to a clinical-trial analysis service is received. Such an indication might be provided by the user or automatically provided (e.g., automatically saved). Thereafter, at block 414, the patient data is provided to the clinical-trial analysis service. The patient data can be provided in any form, such as a CCD (continuity of care document), etc. The patient data can be provided to the clinical-trial analysis service, for example, via a web-based interface (e.g., REST interface). Such patient data might be provided to a patient-data component 212 of FIG. 2 for storage in the patient database 222 of FIG. 2. As can be appreciated, such patient data can be provided to any healthcare system and referenced therefrom. For example, patient data can be provided to a source hosting electronic health records and can be referenced therefrom.

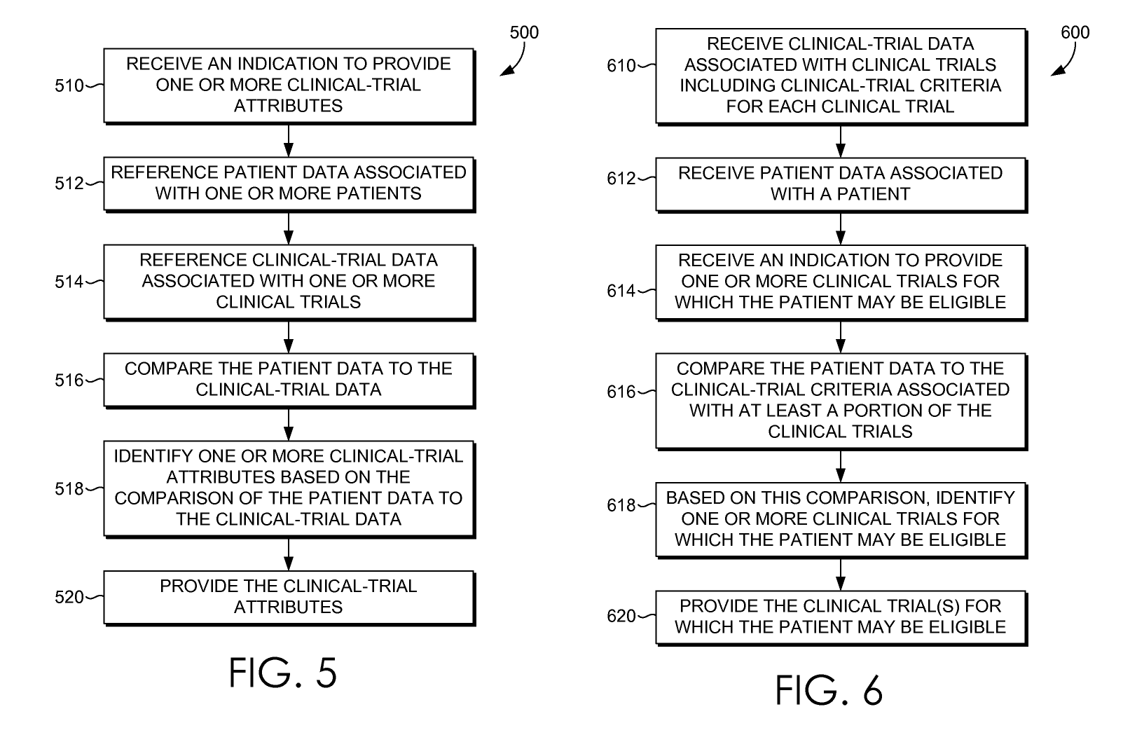

With reference to FIG. 5, a flow diagram showing a method for performing clinical-trial analysis, in accordance with an embodiment of the present invention, is illustrated and designated generally as reference numeral 500. Method 500 may be implemented on the above-described exemplary computing system environment (FIG. 2) and, by way of example only, may be utilized by a clinician or a clinical-trial provider to view various clinical-trial attributes.

Initially, at block 510, an indication to provide one or more clinical-trial attributes is received. For example, a clinician may input a request to view one or more clinical trials that might be available for a particular patient. In another example, a clinical-trial provider may input a request to view data regarding a particular clinical trial (e.g., recommended criteria to modify, etc.). At block 512, patient data associated with one or more patients is referenced. Such patient data can be referenced in accordance with any number of sources, such as, for example, a patient database that is a centralized database containing information associated with a plurality of patients, patient data entered via a clinician application for documenting patient data, patient data entered via a patient application for documenting patient data, or the like. At block 514, clinical-trial data associated with one or more clinical trials is referenced. The clinical trial may be referenced, for example, from a clinical-trial database that is a centralized database containing information associated with a plurality of clinical trials. Subsequently, at block 516, the patient data is compared to the clinical-trial data, such as clinical-trial criteria. At block 518, one or more clinical-trial attributes are identified based on the comparison of the patient data to the clinical-trial data. The clinical-trial attributes are provided, as indicated at block 520. In this regard, the clinical-trial attributes can be provided to a remote computer, such as a user computing device or a clinical-trial provider computing device, for display to a clinician, a patient, a clinical-trial provider, etc.

With reference to FIG. 6, a flow diagram showing a method for performing clinical-trial analysis to obtain a patient report including one or more patient-related attributes, in accordance with an embodiment of the present invention, is illustrated and designated generally as reference numeral 600. Method 600 may be implemented on the above-described exemplary computing system environment (FIG. 2) and, by way of example only, may be utilized by a clinician or a patient to view various patient-related attributes.

Initially, as indicated at block 610, clinical-trial data associated with clinical trials, including clinical-trial criteria for each clinical trial, is received. Such clinical-trial data can be provided by any number of clinical-trial providers, for example, from remote computing devices via a web-based interface. At block 612, patient data associated with a patient is received. In embodiments, the patient data is provided by a clinician or the patient using a remote computing device via a web-based interface. An indication to provide one or more clinical trials for which the patient may be eligible or qualified is received, as indicated at block 614. Subsequently, at block 616, the patient data is compared to the clinical-trial criteria associated with at least a portion of the clinical trials. In some embodiments, the patient data is compared to clinical-trial criteria associated with all available clinical trials. In other embodiments, the patient data is compared to clinical-trial criteria associated with a portion of available clinical trials, such as clinical trials associated with a particular medical condition, clinical trials associated with a particular geographical region, or the like. A category of clinical trials to analyze or screen can be indicated, for example, in association with the indication to provide clinical trials for which the patient may be eligible.

As indicated at block 618, based on the comparison, one or more clinical trials for which the patient may be eligible are identified. In some embodiments, clinical trials for which the patient may be eligible are clinical trials for which the patient data corresponds or matches with each required clinical-trial criteria. In other embodiments, clinical trials for which the patient may be eligible are clinical trials for which the patient data nearly corresponds with the required clinical-trial criteria. Accordingly, a user can be provided with an indication of clinical trials that might be available to the patient in the future. Subsequently, at block 620, the clinical trial(s) for which the patient may be eligible is provided. Accordingly, an indication of the clinical trial(s) can be presented to a remote computing device such that a user (e.g., a clinician or patient) can view possible clinical trials for the patient.

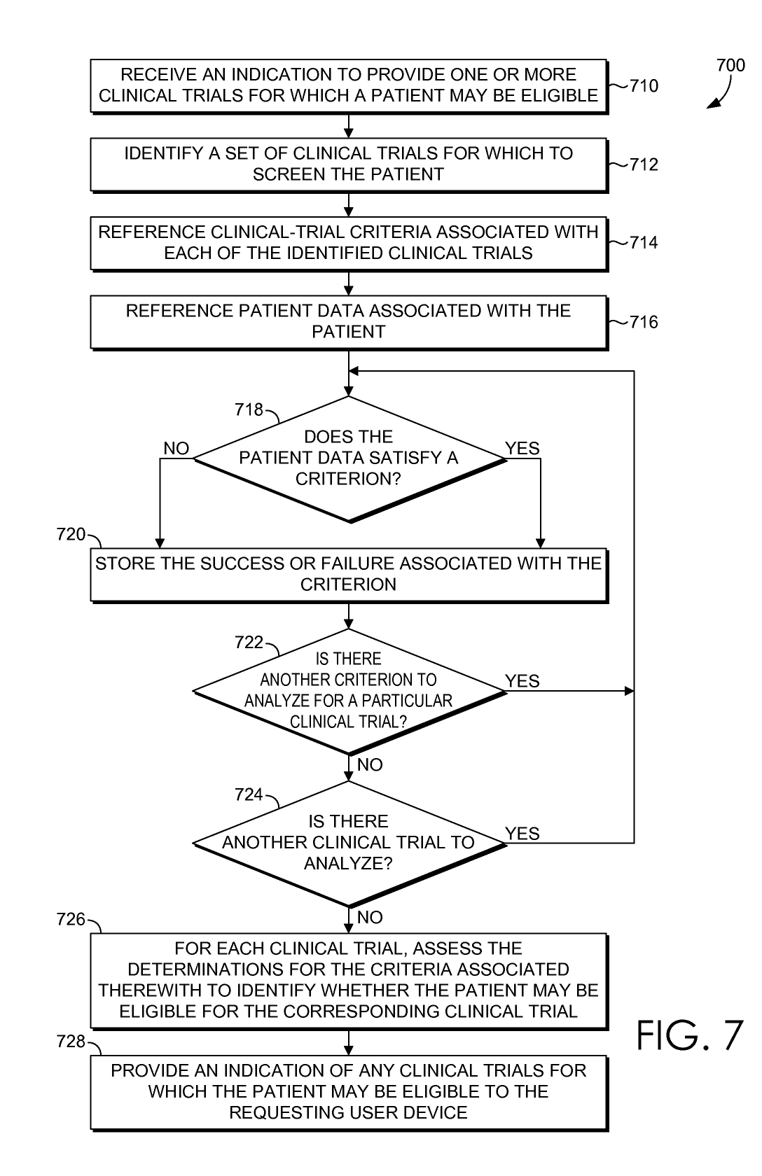

With reference to FIG. 7, a flow diagram showing another method for performing clinical-trial analysis to obtain a patient report including one or more patient-related attributes, in accordance with an embodiment of the present invention, is illustrated and designated generally as reference numeral 700. Method 700 may be implemented on the above-described exemplary computing system environment (FIG. 2) and, by way of example only, may be utilized by a clinician or a patient to view various patient-related attributes.

Initially, as indicated at block 710, an indication to provide one or more clinical trials for which a patient may be eligible is received. Subsequently, at block 712, a set of clinical trials for which to screen the patient is identified. The clinical trials selected for screening a patient may be any number of clinical trials. By way of example only, selected clinical trials may be all clinical trials, clinical trials associated with a specific geographical region (e.g., within a city, a zip code, a state, etc.), clinical trials associated with a specific medical condition, a combination thereof, or the like. The clinical trials to select can be identified using, for example, data contained in a query associated with the indication to provide the clinical trials for which the patient may be eligible.

At block 714, clinical-trial criteria associated with each of the identified clinical trials are referenced. At block 716, patient data associated with the patient is referenced. For each clinical-trial criterion associated with a clinical trial, a determination is made whether the patient data satisfies a particular criterion. This indicated at block 718. At block 720, the determination is stored. In this way, the success or failure associated with the criterion is stored. Other data, such as variance from the criterion, can be determined and stored as well. At block 722, it is determined if there is another criterion to analyze for the clinical trial. If so, the method returns to block 718, and a determination is made as to whether patient data meets the particular criterion. If not, the method proceeds to block 724 at which it is determined if there is another clinical trial to analyze. If there is another clinical trial to analyze, the method returns to block 718, and a determination is made as to whether patient data meets the particular criterion for a particular clinical trial. If there is not another clinical trial to analyze, the method continues to block 726. As indicated at block 726, for each clinical trial, the determinations for the criteria associated therewith are assessed to identify whether the patient is eligible for the corresponding clinical trial. In some embodiments, such an indication can be based on recognizing whether each required criteria is satisfied (e.g., inclusion and exclusion criteria). In other embodiments, such an indication can be based on recognizing whether a particular portion of required criteria is satisfied (e.g., each required criteria, a percent, etc.). At block 728, any clinical trials for which the patient is eligible or qualifies is provided to the requesting user device for display to the user. As can be appreciated, match scores can also be calculated and provided to the requesting user device. Accordingly, the clinical trials for which the patient qualifies can be ranked and displayed in order of match score to the user.

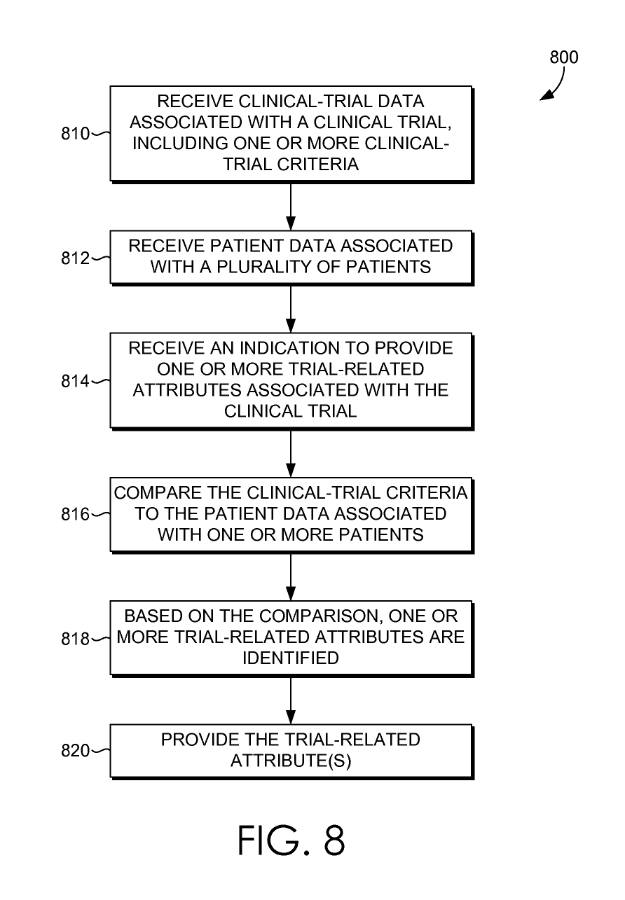

With reference to FIG. 8, a flow diagram showing a method for performing clinical-trial analysis to obtain a clinical-trial report including one or more trial-related attributes, in accordance with an embodiment of the present invention, is illustrated and designated generally as reference numeral 800. Method 800 may be implemented on the above-described exemplary computing system environment (FIG. 2) and, by way of example only, may be utilized by a clinical-trial provider to view various trial-related attributes.

Initially, as indicated at block 810, clinical-trial data associated with a clinical trial, including clinical-trial criteria for the clinical trial, is received. Such clinical-trial data can be provided by a clinical-trial provider, for example, from a remote computing device via a web-based interface. At block 812, patient data associated with a plurality of patients is received. In embodiments, the patient data is provided by a clinician and/or patients using remote computing devices via a web-based interface. An indication to provide one or more trial-related attributes associated with the clinical trial is received, as indicated at block 814. Subsequently, at block 816, the clinical-trial criteria is compared to the patient data associated with one or more patients. In some embodiments, the clinical-trial criteria is compared to patient data associated with all of the plurality of patients. In other embodiments, the clinical-trial criteria is compared to patient data associated with a portion of the plurality of patients, such as patients associated with a particular medical condition, patients associated with a particular geographical region, patients for which a screening has been initiated or performed, or the like. A category of patients to analyze in light of the clinical trial can be indicated, for example, in association with the indication to provide a clinical-trial report.

As indicated at block 818, based on the comparison, one or more trial-related attributes are identified. Examples of such trial-related attributes may be, for example, success or failure of criteria associated with the clinical trial, variance of data from criteria associated with the clinical trial, a suggested modification to make to criteria associated with the clinical trial, an anticipated result of employing the suggested modification, a distribution of patient data relative to criteria, and/or the like. By way of example only, a distribution of patient data relative to the criteria can be recognized. In some embodiments, the data can be classified into various groups of data, such as, for example, data qualifying in a first value range, data qualifying in a second value range, etc. Upon recognizing and analyzing such a distribution, a suggested criteria modification can be determined. The suggested criteria modification can be used to increase the potential number of patients eligible for the clinical trial. Subsequently, at block 820, the trial-related attribute(s) are provided. Accordingly, an indication of the trial-related attribute(s) can be presented to a remote computing device such that a clinical-trial sponsor can view the trial-related attributes associated with the clinical trial.

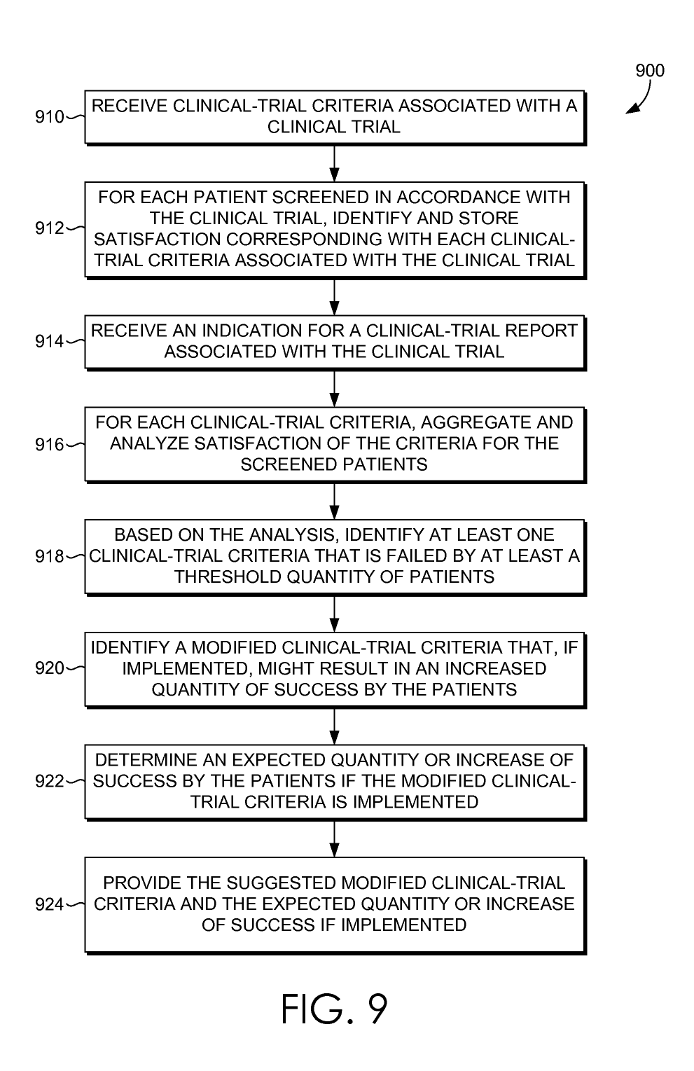

Turning now to FIG. 9, a flow diagram showing another method for performing clinical-trial analysis to obtain a clinical-trial report including one or more trial-related attributes, in accordance with an embodiment of the present invention, is illustrated and designated generally as reference numeral 900. Method 900 may be implemented on the above-described exemplary computing system environment (FIG. 2) and, by way of example only, may be utilized by a clinical-trial provider to view various trial-related attributes.

Initially, as indicated at block 910, clinical-trial criteria associated with a clinical trial is received. Such clinical-trial criteria can be provided by a clinical-trial provider via a user interface. At block 912, for each patient screened in accordance with the clinical trial, satisfaction corresponding with each clinical-trial criteria associated with the clinical trial is identified and stored. In this regard, over a period of time, satisfaction of patient data in association with clinical-trial criteria is determined for patients that are screened to determine eligibility for the clinical trial. By way of example only, a first patient may be screened for the clinical trial based on association with a particular medical condition and analysis of each criteria of the clinical trial can be identified and logged. Further, a second patient may be screened for the clinical trial based on association with the same medical condition and analysis of each criteria of the clinical trial can be identified and logged.

At block 914, an indication for a clinical-trial report associated with the clinical trial is received. Such an indication can be provided by a clinical-trial provider, for example, via a remote computing device. At block 916, satisfaction of the criteria for the screened patients is aggregated and analyzed for each clinical-trial criteria. As such, in some embodiments, success or failure rates or numbers, or variances associated therewith, associated with each clinical-trial criteria can be determined. Based on the analysis, as indicated at block 918, at least one clinical-trial criteria that is failed by at least a threshold quantity of patients is identified. Such a threshold may indicate a number or percent of patients that have failed to meet the clinical-trial criteria and, accordingly, may be considered ineligible for the clinical trial. At block 920, a modified clinical-trial criteria that, if implemented, might result in an increased quality of success by the patients is identified. At block 922, an expected quantity or increase of success in meeting the criteria if the modified clinical-trial criteria is implemented is determined. Subsequently, at block 924, the suggested modified clinical-trial criteria and/or the expected quantity of increase of success, if implemented, are provided. Although FIG. 9 illustrates the indication for the clinical-trial report being received prior to aggregating and analyzing satisfaction of the criteria for the screened patients, in other embodiments, such aggregation and analysis can be ongoing such that upon receiving an indication for a clinical-trial report, the ongoing monitored data can be immediately output to the requestor.

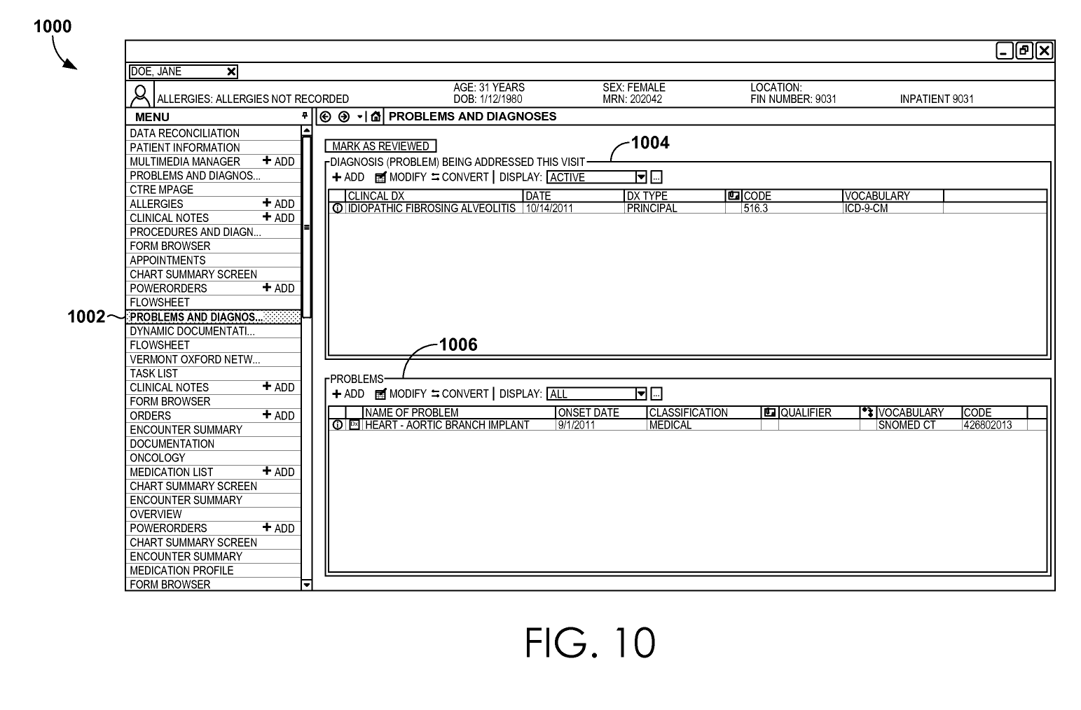

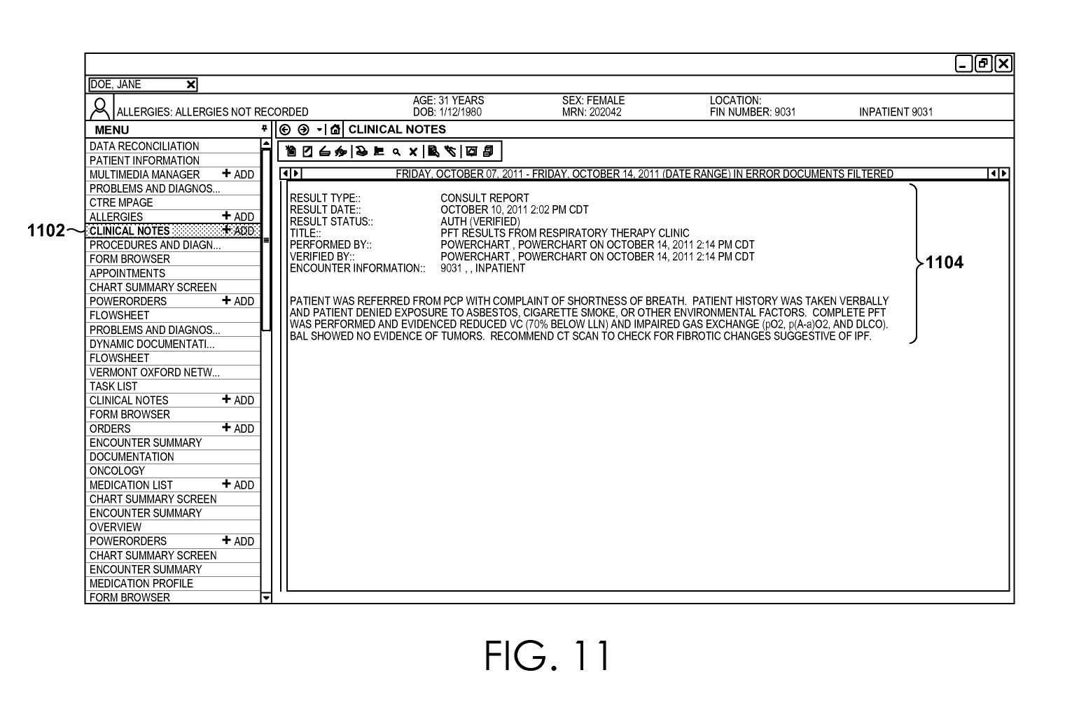

In operation, an example of providing patient-related attributes will now be described with reference to FIGS. 10-12, which include screen displays illustrating user interfaces for providing patient-related attributes in accordance with an embodiment of the present invention. The present example is related to viewing one or more clinical trials related to a medical condition associated with a patient. Initially, FIG. 10 illustrates a screen display of an exemplary view of a chart 1000 for a patient. As illustrated in FIG. 10, a clinician can select to view “Problems and Diagnosis” 1002 to document and/or view documentation associated with a diagnosis 1004 being addressed and documentation associated with a problem(s) 1006 for the patient. As shown in FIG. 10, a diagnosis and problem has been populated into the chart 1002. With reference now to FIG. 11, the clinician can select “Clinical Notes” 1102 to input and/or view clinical notes 1104 associated with a patient visit.

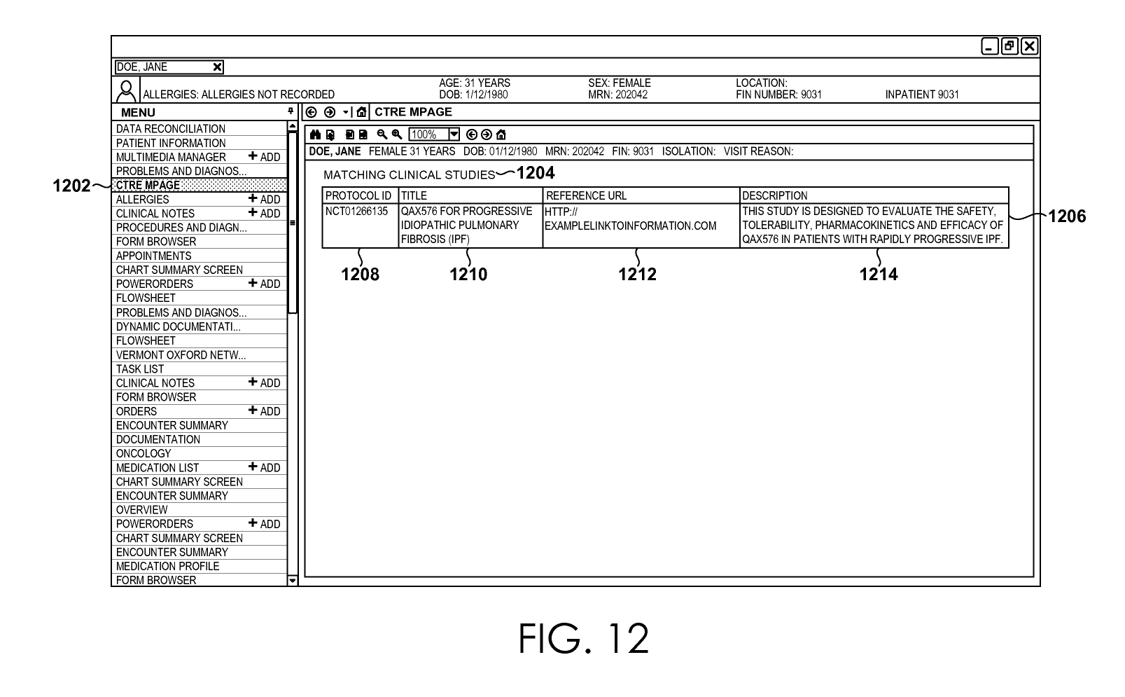

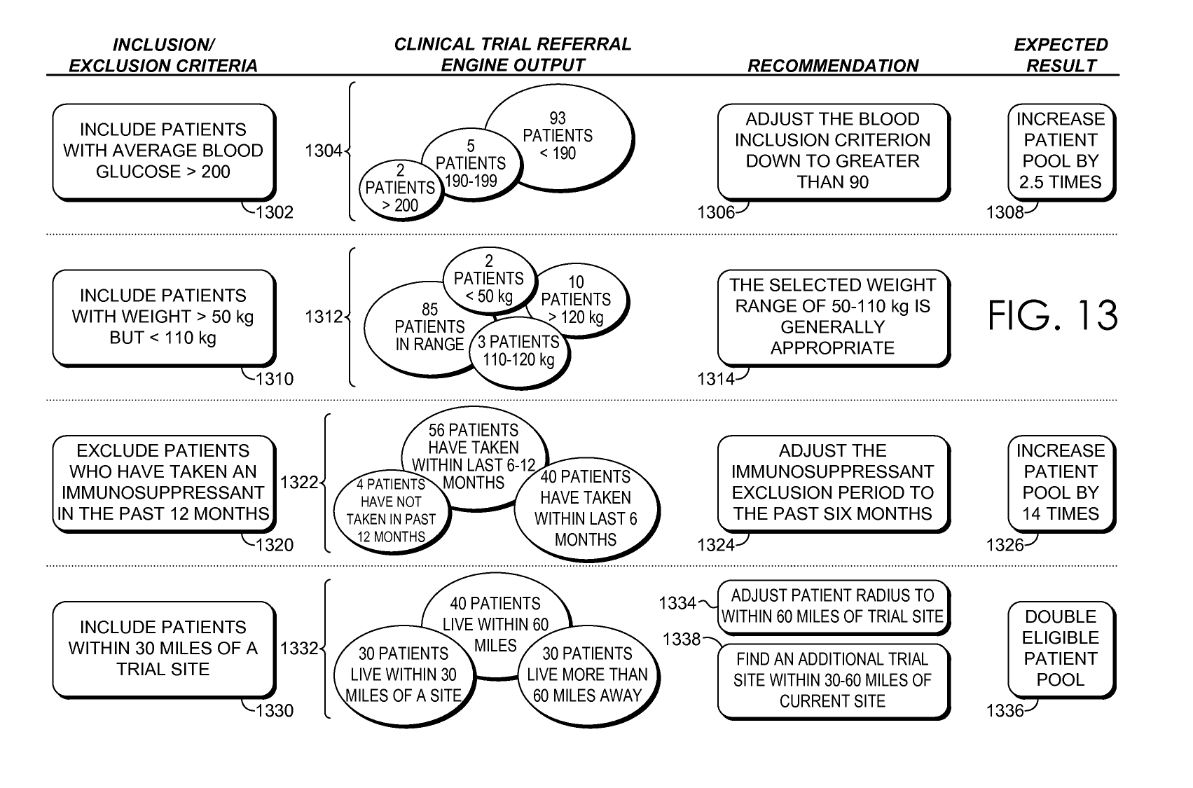

Turning now to FIG. 12, to view one or more clinical trials for which the patient may be eligible, the clinician can select to view “CTRE MPage” 1202, which provides a listing of one or more clinical trials for which a patient may qualify. Upon selecting the tab 1202, a listing of matching clinical studies 1204 is provided. In the illustrated example, the clinical trial 1206 that matches the patient's diagnosis of Idiopathic Fibrosing Alveolitis and other patient data is a clinical trial titled Progressive Idiopathic Pulmonary Fibrosis (IPF). Along with the protocol ID 1208 and the title 1210 for the matching clinical study, a reference URL 1212 and a description 1214 of the clinical study can also be provided. The reference URL 1212 can provide a source of information so that the clinician and/or patient can more readily locate details regarding the clinical trial. The description 1214 can also provide a summary and/or details regarding the clinical trial for easy access by the clinician and/or patient. The clinician and patient can then discuss, for example, benefits and drawbacks of the clinical trial, whether the patient should pursue the clinical trial, or the like.

An example of providing trial-related attributes will now be described with reference to FIG. 13. As can be appreciated, a clinical-trial report and/or trial-related attributes can be presented in any manner, and the illustration provided herein is not meant to limit the scope of the invention.

In relation to FIG. 13, assume that over a time period, such as 30 days, 100 patients have been screened against the inclusion and exclusion criteria for Trial XYZ. Further assume that the 100 patients were screened by 38 different clinicians at twelve medical facilities. Based on the data aggregated from these screenings, various trial-related attributes can be provide, for example, to a clinical-trial provider associated with Trial XYZ.

FIG. 13 illustrates four different criteria associated with the Trial XYZ. Inclusion criteria 1302 indicates to include patients as an eligible candidate that have an average blood glucose greater than 200. Based on the aggregated data associated with criteria 1302 from the 100 patient screenings, it is recognized that only two patients had an average blood glucose of greater than 200, five patients had an average blood glucose between 190 and 199, and 93 patients had an average blood glucose of less than 190. Such trial-related attributes 1304 associated with criteria 1302 can be provided, for example, in a clinical-trial report. As can be appreciated, the trial-related attributes 1304 can represent a distribution of patient data relative to the criteria 1302. As shown in FIG. 13, such a distribution of patient data can be grouped into various categories of values (e.g., various ranges of values). In other cases, a distribution of patient data can be illustrated as discrete patient data points. A suggested criteria modification can also be identified and provided via a clinical-trial report. Based on the trial-related attributes 1304 associated with the criteria 1302, the clinical-trial analysis service can provide a recommendation 1306 to modify the clinical criteria to improve the clinical trial or increase the number of potential participants. Accordingly, the recommendation 1306 provided for criteria 1302 includes adjusting the blood glucose inclusion criterion down from “greater than 200” to “greater than 190.” An expected result 1308 indicates that such a modification may increase the eligible patient pool for Trial XYZ by two and a half times.

Inclusion criteria 1310 indicates to include patients as an eligible candidate that have a weight over 50 kg but less than 110 kg. Based on the aggregated data associated with criteria 1310 from the 100 patient screenings, it is recognized that only two patients had a weight below 50 kg, three patients had a weight between 110-120 kg, 10 patients had a weight greater than 120 kg, and 85 patients fall in the required weight range between 50 kg and 110 kg. Such trial-related attributes 1312 associated with criteria 1310 can be provided, for example, in a clinical-trial report. Based on the trial-related attributes 1312 associated with the criteria 1310, the clinical-trial analysis service can provide a recommendation 1314 that the weight range selected for the clinical trial is generally appropriate.

Exclusion criteria 1320 indicates to exclude patients as an eligible candidate that have taken an immunosuppressant in the past twelve months. Based on the aggregated data associated with criteria 1320 from the 100 patient screenings, it is recognized that only four of the 100 patients qualified under the current criterion of not having taken an immunosuppressant medication in the past twelve months. Fifty six patients had taken an immunosuppressant within the last twelve months, but not within the last six months, while 40 patients had taken an immunosuppressant within the past six months. Such trial-related attributes 1322 associated with criteria 1320 can be provided, for example, in a clinical-trial report. A suggested criteria modification can also be identified and provided via a clinical-trial report. Based on the trial-related attributes 1322 associated with the criteria 1320, the clinical-trial analysis service can provide a recommendation 1324 to adjust the clinical criteria to improve the clinical trial or increase the number of potential participants. Accordingly, the recommendation 1324 provided for criteria 1320 includes adjusting the immunosuppressant exclusion period from the past twelve months to the past six months. An expected result 1326 indicates that such a modification may increase the eligible patient pool for Trial XYZ by fourteen times.

Inclusion criteria 1330 indicates to include patients as an eligible candidate that live within thirty miles of the trial site for Trial XYZ. Based on the aggregated data associated with criteria 1330 from the 100 patient screenings, it is recognized that 30 of the 100 patients screened had home addresses within 30 miles of the site, 40 patients live within 60 miles of the site, and 30 patients live more than 60 miles away from the site. Such trial-related attributes 1332 associated with criteria 1330 can be provided, for example, in a clinical-trial report. A suggested criteria modification can also be identified and provided via a clinical-trial report. Based on the trial-related attributes 1332 associated with the criteria 1330, the clinical-trial analysis service can provide a recommendation 1334 to modify the clinical criteria to improve the clinical trial or increase the number of potential participants. Accordingly, the recommendation 1334 provided for criteria 1330 includes adjusting the patient living radius up from “within 30 miles of the trial site” to “within 60 miles of the trial site.” An expected result 1336 indicates that such a modification may double the eligible patient pool for Trial XYZ. An additional or alternative recommendation 1338 provided for criteria 1330 includes a recommendation to find an additional clinical trial site for patients within a 30-60 mile radius of the current site, which may provide the expected result 1336 of doubling the eligible patient pool. For example, finding a clinical-trial site in zip code 55555 would put 34 of those 40 patients within 30 miles of the second site.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

What is claimed is:

1. One or more computer-storage media having computer-executable instructions embodied thereon for performing a method for providing indications of trial-related attributes, the method comprising:
aggregating data associated with a plurality of patients that correspond with a criterion associated with a clinical trial, the criterion providing a qualification used to determine whether a patient is eligible for the clinical trial;
based on the aggregated data corresponding with the criterion for the clinical trial, identifying one or more clinical-trial attributes that indicate satisfaction of the criterion associated with the clinical trial; and
providing the one or more clinical-trial attributes indicating satisfaction of the criterion associated with the clinical trial.

2. The media of claim 1, wherein the data associated with each of the plurality of patients indicates a value relative to the criterion.

3. The media of claim 1, wherein the criterion is related to a medical condition, a medication usage, a patient demographic, a patient lab result, a patient travel distance, a patient symptom, a patient weight, a patient height, a patient body mass index, or a patient vital.

4. The media of claim 1, wherein the plurality of patients comprise patients screened for the clinical trial.

5. The media of claim 1, wherein the criterion comprises an exclusion criterion that excludes patients from the clinical trial or an inclusion criterion that includes patients to clinical trial.

6. The media of claim 1, wherein the data associated with the plurality of patients is received from a plurality of clinicians.

7. The media of claim 1, wherein the one or more clinical-trial attributes that indicate satisfaction of the criterion associated with the clinical trial comprise an indication of a patient success rate for the criterion, an indication of a patient failure rate for the criterion, an indication of an extent of patients that do not satisfy the criterion but are within a threshold or threshold range from the criterion, an indication of an extent that patient data fails to exist for the criterion, an indication of a distribution of the data relative to the criterion, or a combination thereof.

8. The media of claim 1, wherein the one or more clinical-trial attributes that indicate satisfaction of the criterion associated with the clinical trial comprise a modification of the criterion that, if implemented, is expected to increase a number of patients eligible for the clinical trial.

9. The media of claim 8, further comprising determining an expected result for implementation of the modification of the criterion.
